(19) United States
(12) Patent Application Publication
(10) Pub. No.: US 2023/0254561 A1
(43) Pub. Date: Aug. 10, 2023

(54) CAMERA MODULE

(71) Applicant: LG INNOTEK CO., LTD., Seoul (KR)

(72) Inventor: Eun Sung SEO, Seoul (KR)

(21) Appl. No.: 17/996,683

(22) PCT Filed: Apr. 20, 2021
(86) PCT No.: PCT/KR2021/004951

§ 371 Date: Oct. 20, 2022

(30) Foreign Application Priority Data
Apr. 20, 2020 (KR) 10-2020-0047484
Apr. 19, 2021 (KR) 10-2021-0050457

(51) Int. Cl. H04N 23/55; H04N 23/57; G03B 5/00

(52) U.S. Cl. CPC H04N 23/55; G03B 5/00; H04N 23/57; G03B 2205/0007; G03B 2205/0053

(57) ABSTRACT

An embodiment of the present invention provides a camera module comprising: a fixed part; a moving part which moves relative to the fixed part in an optical axis direction; a first driving part which moves the moving part at a first maximum speed; and a second driving part which moves the moving part at a second maximum speed, wherein the first driving part and the second driving part move the moving part in a direction perpendicular to the optical axis direction, and the second maximum speed is greater than the first maximum speed.

### TECHNICAL FIELD

The present invention relates to a camera module

### BACKGROUND ART

Cameras are apparatuses which capture images or moving images of subjects and are installed in portable devices, drones, vehicles, and the like. In order to improve the quality of an image, a camera device or camera module may have an image stabilization (IS) function that corrects or prevents image shake caused by user movement, an auto focusing (AF) function that automatically adjusts a distance between an image sensor and a lens so as to arrange the focal length of the lens, and a zooming function that increases or decreases a magnification so as to capture an image of a subject from a long distance

Meanwhile, when the number of pixels of the image sensor increases, the resolution increases, and the size of a pixel decreases. As the size decreases, the amount of light received by a pixel for the same time decreases. Accordingly, as the number of pixels of a camera increases, an image shake phenomenon caused by hand shake occurring due to a decrease in shutter speed in a dark environment may more severely occur An optical image stabilization (OIS) technology for correcting movement by changing an optical path is a typical image stabilization technology.

According to the general OIS technology, the movement of a camera can be detected by a gyro sensor or the like, and then a lens or a camera module including a lens and an image sensor can be tilted or moved based on the detected movement. When the lens or the camera module including the lens and the image sensor is tilted or moved for OIS, a space for tilting or moving needs to be additionally secured around the lens or the camera module.

Meanwhile, an actuator for the OIS may be disposed around the lens. In this case, the actuator for the OIS may be an actuator in charge of tilting or parallel movement on two axes perpendicular to an optical axis.

In addition, due to recent needs for ultra-slim and ultra-small camera devices, there have been many spatial restrictions on the arrangement of an actuator for OIS and the like, and there is a problem that it is difficult to secure a sufficient space for a lens or a camera module including a lens and an image sensor to tilt or move for the OIS. In addition, as the number of pixels of a camera increases, it is preferable for a size of the lens to increase in order to increase an amount of received light, but there may be a limit on increasing the size of the lens due to a space occupied by the actuator for the OIS.

In addition, there is a problem that a suppression ratio changes according to a field of view when the lens is tilted or moved for the OIS.

### TECHNICAL PROBLEM

The present invention is directed to providing a camera module with an improved suppression ratio even when a field of view is changed.

In addition, the present invention is directed to providing a camera module which reduces the number of pixels which shake an image according to a change in field of view during image capturing.

In addition, the present invention is directed to providing a camera module which easily prevents image shake even at a small field of view.

### TECHNICAL SOLUTION

One aspect of the present invention provides a camera module including a fixed part, a moving part which moves relative to the fixed part in an optical axis direction, a first driving part which moves the moving part at a first maximum speed, and a second driving part which moves the moving part at a second maximum speed, wherein the first driving part and the second driving part move the moving part in a direction perpendicular to the optical axis direction, and the second maximum speed is higher than the first maximum speed.

The fixed part may include at least one of a housing and a base, and the moving part may include at least one of a lens part and an image sensor.

The lens part may be disposed in the housing, the lens part may include a lens holder and a lens assembly disposed in the lens holder, and the image sensor may be disposed in the base.

The first driving part may move the moving part to correspond to a shaking angle.

The second driving part may move the moving part to compensate for a difference between the shaking angle and a moving angle caused by the first driving part.

The second driving part may move the moving part to correspond to an error between the first driving part and the shaking angle at a different time after the first driving part moves the moving part at the moving angle.

The first driving part and the second driving part may be selectively controlled according to a focal length between the lens assembly and the image sensor.

When the focal length is greater than a first threshold, the moving part may be moved by the first driving part and the second driving part.

When the focal length is smaller than the first threshold and greater than a second threshold, the moving part may be moved by the first driving part, and the first threshold may be greater than the second threshold.

When the focal length is smaller than the second threshold, the moving part may be moved by the second driving part

### ADVANTAGEOUS EFFECTS

According to embodiments, the present invention can provide a camera actuator applicable to an ultra-slim camera, an ultra-small camera, and a high-resolution camera. Particularly, even without increasing an overall size of the camera device, an actuator for optical image stabilization (OIS) can be effectively disposed.

According to the embodiments, the camera module with an improved suppression ratio even when a field of view is changed can be implemented.

According to the embodiments, a camera module that reduces the number of pixels which shake an image according to a change in field of view during image capturing can be implemented.

In addition, according to the embodiments, a camera module that easily prevents image shake even at a small field of view can be implemented.

### DESCRIPTION OF DRAWINGS

FIG. 1A is a schematic view illustrating a camera module according to an embodiment of the present invention.

FIG. 1B is a conceptual view illustrating a first example of a camera module.

FIG. 1C is a conceptual view illustrating a second example of a camera module.

FIG. 1D is a conceptual view illustrating a third example of a camera module.

FIG. 1E is a conceptual view illustrating a fourth example of a camera module.

FIG. 1F is a conceptual view illustrating a fifth example of a camera module.

FIG. 1G is a conceptual view illustrating a sixth example of a camera module.

FIG. 1H is a conceptual view illustrating a seventh example of a camera module.

FIG. 1I is a conceptual view illustrating an eighth example of a camera module.

FIG. 1J is a conceptual view illustrating a ninth example of a camera module.

FIG. 1K is a conceptual view illustrating a tenth example of a camera module.

FIG. 1L is a conceptual view illustrating an eleventh example of a camera module.

FIG. 1M is a conceptual view illustrating a twelfth example of a camera module.

FIG. 1N is a conceptual view illustrating a thirteenth example of a camera module.

FIG. 2 is a configuration view illustrating a camera module according to a first embodiment.

FIG. 3 is a view for describing a first driving part according to an embodiment.

FIG. 4 is a view for describing a second driving part according to an embodiment.

FIGS. 5 and 6 are views for describing an operation of performing optical image stabilization (OIS) according to a field of view of a camera module according to an embodiment.

FIG. 7 is a view for describing a change in movement angle for OIS of a camera module according to an embodiment.

FIG. 8 is a view for describing a change in movement angle for OIS of a camera module according to another embodiment.

FIGS. 9 and 10 are views for describing an OIS operation of a camera module according to a modified embodiment of FIG. 2.

FIG. 11 is a configuration view illustrating a camera module according to a second embodiment.

FIG. 12 is a configuration view illustrating a camera module according to a third embodiment.

FIG. 13 is a cross-sectional view along line AA′ in FIG. 12.

FIGS. 14 to 16 are views for describing OIS of a first camera actuator of the camera module according to the third embodiment.

FIG. 17 is a view for describing OIS of a second camera actuator of the camera module according to the third embodiment.

FIG. 18 is a view for describing OIS using an image sensor of the camera module according to the third embodiment.

FIG. 19 is a configuration view illustrating a camera module according to another modified embodiment.

FIG. 20 is a view illustrating an electronic device including a camera module according to an embodiment.

### MODES OF THE INVENTION

Since the present invention allows various changes and has many embodiments, specific embodiments will be illustrated in the accompanying drawings and described. However, this is not intended to limit the present invention to the specific embodiments, and it is to be appreciated that all changes, equivalents, and substitutes that fall within the spirit and technical scope of the present invention are encompassed in the present invention.

Although the terms “first,” “second,” and the like may be used herein to describe various elements, these elements should not be limited by these terms. These terms are only used to distinguish one element from another element. For example, a second element could be termed a first element, and a first element could similarly be termed a second element without departing from the scope of the present invention. The term “and/or” includes any one or any combination among a plurality of associated listed items.

When an element is referred to as being “connected” or “coupled” to another element, it will be understood that the element can be directly connected or coupled to another element, or other elements may be present therebetween. In contrast, when an element is referred to as being “directly connected” or “directly coupled” to another element, it will be understood that there are no intervening elements.

The terminology used herein is for the purpose of describing particular embodiments only and is not intended to limit the present invention. The singular forms are intended to include the plural forms, unless the context clearly indicates otherwise. In the present specification, it should be understood that the terms “comprise,” “comprising,” “include,” and/or “including,” when used herein, specify the presence of stated features, numbers, steps, operations, elements, components, and/or combinations thereof but do not preclude the presence or addition of one or more other features, numbers, steps, operations, elements, components, and/or combinations thereof.

Unless otherwise defined, all terms including technical and scientific terms used herein have meanings which are the same as meanings generally understood by those skilled in the art. Terms, such as those defined in generally used dictionaries, should be interpreted as having meanings that are consistent with their meanings in the context of the relevant art and will not be interpreted in an idealized or overly formal sense unless expressly so defined here.

Hereinafter, when embodiments are described in detail with reference to the accompanying drawings, components that are the same or correspond to each other will be denoted by the same or corresponding reference numerals in all drawings, and redundant descriptions will be omitted.

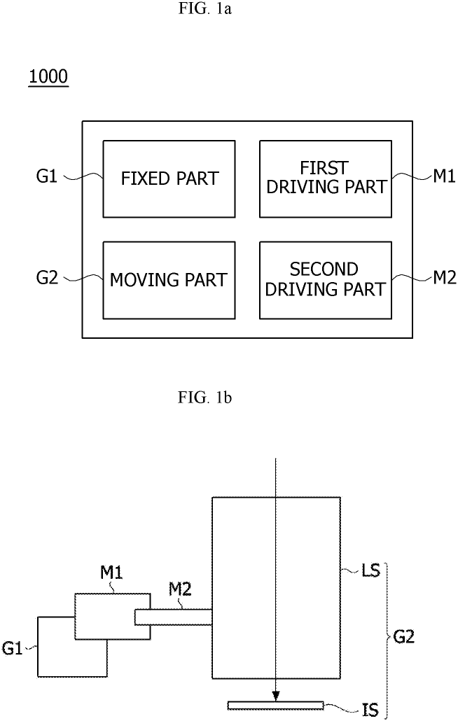

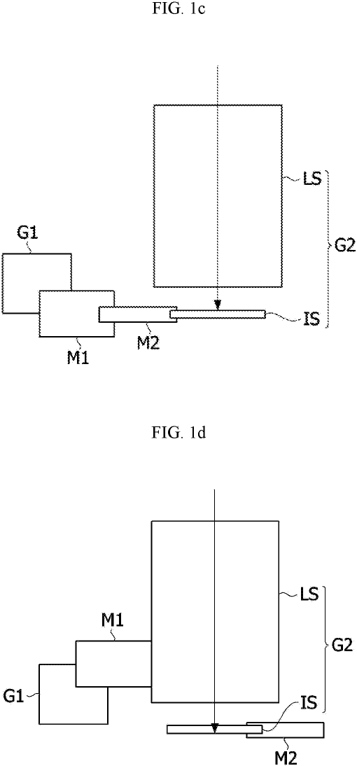

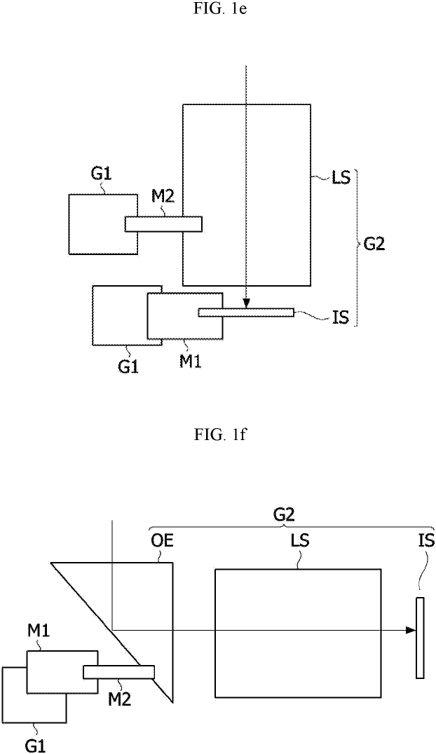

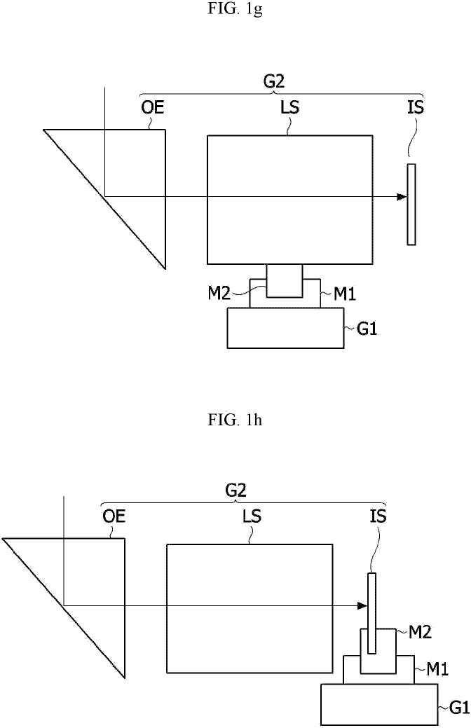

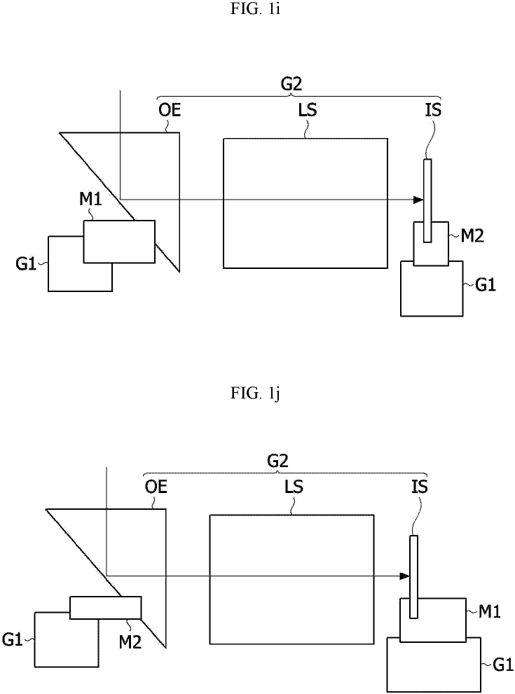

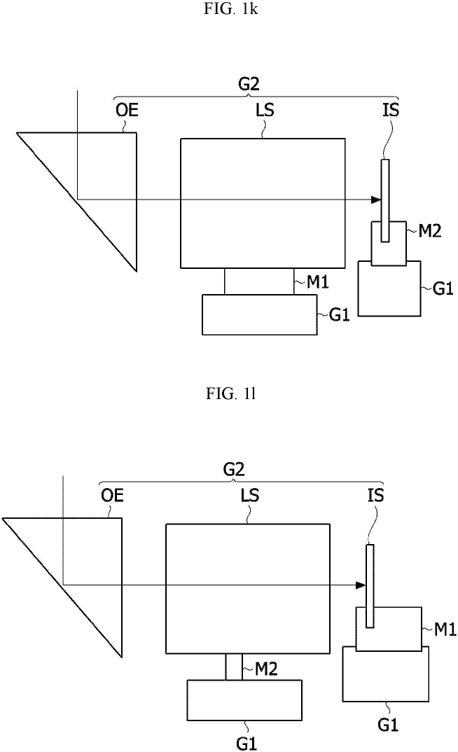

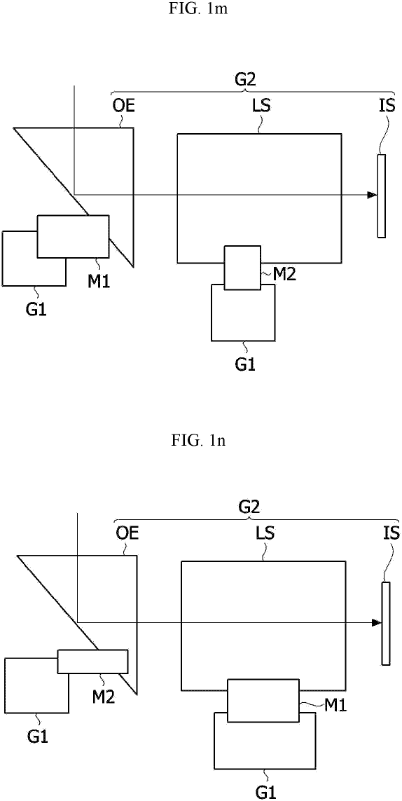

FIG. 1A is a schematic view illustrating a camera module according to an embodiment of the present invention. FIG. 1B is a conceptual view illustrating a first example of a camera module. FIG. 1C is a conceptual view illustrating a second example of a camera module. FIG. 1D is a conceptual view illustrating a third example of a camera module. FIG. 1E is a conceptual view illustrating a fourth example of a camera module. FIG. 1F is a conceptual view illustrating a fifth example of a camera module. FIG. 1G is a conceptual view illustrating a sixth example of a camera module. FIG. 1H is a conceptual view illustrating a seventh example of a camera module. FIG. 1I is a conceptual view illustrating an eighth example of a camera module. FIG. 1J is a conceptual view illustrating a ninth example of a camera module. FIG. 1K is a conceptual view illustrating a tenth example of a camera module. FIG. 1L is a conceptual view illustrating an eleventh example of a camera module. FIG. 1M is a conceptual view illustrating a twelfth example of a camera module. FIG. 1N is a conceptual view illustrating a thirteenth example of a camera module.

Referring to FIG. 1A, a camera module 1000 according to the embodiment of the present invention may include a fixed part G1, a moving part G2, a first driving part M1, and a second driving part M2.

The fixed part G1 may include fixed components in the camera module 1000. That is, the fixed part G1 may include components which do not move when auto focusing (AF) and optical image stabilization (OIS) are performed. Particularly, in the present invention, the fixed part G1 may include components which do not move when OIS or AF is performed.

For example, in the camera module 1000 according to the embodiment, the fixed part G1 may include at least one of a housing and a base. In addition, as described above, the concept of the fixed part G1 may include all components which do not move when the AF and the OIS are performed.

The moving part G2 may include moving components in the camera module 1000. That is, the moving part G2 may include components which move when the AF and the OIS are performed. Particularly, in the present invention, the moving part G2 may include components which move when the OIS is performed. Accordingly, in the embodiment, the moving part G2 may move in a direction perpendicular to an optical axis direction or tilt. For example, the moving part G2 may move in a first axis direction or a second axis direction perpendicular to the first axis direction. In other words, the moving part G2 may move in a direction perpendicular to the optical axis direction or tilt to change an optical path. For example, in the camera module 1000 according to the embodiment, the moving part G2 may include at least one among a lens part, an optical path changing part (used interchangeably with an “optical member” including a mirror or prism), and an image sensor. In addition, the concept of the moving part G2 may include all components which move when the OIS or AF is performed

In addition, in the embodiment, the moving part G2 may move in the optical axis direction or tilt. For example, the moving part G2 may move in a third axis direction perpendicular of a first axis and a second axis. This enables the AF and the OIS to be performed.

The first driving part M1 and the second driving part M2 may move the moving part G2 so that the moving part G2 is moved relative to the fixed part G1. In this case, the first driving part M1 and the second driving part M2 may move the moving part G2 in the optical axis direction, move the moving part G2 in a direction perpendicular to the optical axis direction (Y-axis direction or Z-axis direction), or tilt the moving part G2. Particularly, the first driving part M1 and the second driving part M2 according to the embodiment may move the moving part G2 in the same direction. In other words, driving directions of the moving part G2 by the first driving part M1 and the second driving part M2 may be the same. For example, the first driving part M1 and the second driving part M2 may move the moving part G2 in the direction perpendicular to the optical axis direction or tilt the moving part G2.

The first driving part M1 and the second driving part M2 may include various actuators. For example, each of the first driving part M1 and the second driving part M2 may include one among a voice coil motor (VCM) actuator, an actuator driven by a piezoelectric force, a microelectromechanical systems (MEMS) actuator driven in a capacitive manner, a shape memory alloy (SMA) actuator, and an actuator using a fluid.

Distances or tilting angles of the moving part G2 moved by the first driving part M1 and the second driving part M2 may be different.

In addition, degrees of accuracy of the first driving part M1 and the second driving part M2 which move or tilt the moving part G2 may be different from each other.

For example, although the first driving part M1 may move or tilt the moving part G2 to a long distance or at a large angle compared to the second driving part M2, the degree of accuracy of the first driving part M1 may be low. Although the second driving part M2 may move or tilt the moving part G2 to a short distance or at a small angle compared to the first driving part M1, the degree of accuracy of the second driving part M2 may be high. The features of the first driving part M1 and the features of the second driving part M2 described above may be interchangeable. The first driving part M1 and the second driving part M2 may have a complementary relationship. In the embodiment, the degree of accuracy may be related (inversely proportional) to a minimum movement unit of the driving part (for example, the first driving part or the second driving part). More specifically, as the minimum movement unit becomes small, the degree of accuracy may be higher. For example, as described above, the degree of accuracy of the first driving part M1 may be lower than the degree of accuracy of the second driving part M2. Alternatively, the minimum movement unit of the first driving part M1 may be greater than the minimum movement unit of the second driving part M2.

In addition, in the embodiment, the degree of accuracy of the second driving part M2 may be three times the degree of accuracy of the first driving part M1. For example, a ratio of the degree of accuracy the first driving part M1 to the degree of accuracy of the second driving part M2 may be in the range of 1:3 to 1:1000. Specifically, the ratio of the degree of accuracy of the first driving part M1 to the degree of accuracy of the second driving part M2 may be in the range of 1:10 to 1:800. More specifically, the ratio of the degree of accuracy of the first driving part M1 to the degree of accuracy of the second driving part M2 may be in the range of 1:50 to 1:200.

In addition, in the embodiment, the minimum movement unit of the first driving part M1 may be three times the minimum movement unit of the second driving part M2. For example, a ratio of the minimum movement unit of the second driving part M2 to the minimum movement unit of the first driving part M1 may be in the range of 1:3 to 1:1000.

In addition, speeds at which the first driving part M 1 and the second driving part M2 move or tilt the moving part G2 may be different from each other.

More specifically, maximum speeds of the first driving part M1 and the second driving part M2 for moving the moving part G2 may be different from each other.

In the embodiment, the first driving part M1 may move the moving part G2 at a first maximum speed or lower. In addition, the second driving part M2 may move the moving part G2 at a second maximum speed or lower. In addition, the second maximum speed may be higher than the first maximum speed.

In other words, minimum times taken for the first driving part M1 and the second driving part M2 to move the moving part G2 at the same angle (or moving angle) or distance (or moving distance) may be different from each other. For example, the minimum time of the first driving part M1 may be longer than the minimum time of the second driving part M2 to move the moving part G2 at a certain angle (or moving angle) or a distance (or moving distance).

Alternatively, times of the first driving part M1 and the second driving part M2 to reach normal states after driving signals are applied may be different from each other. Alternatively, time differences (hereinafter, driving time differences) between 10% of the normal states and 90% of the normal states of the first driving part M1 and the second driving part M2 after driving signals are applied may be different. That is, the driving time difference of the first driving part M1 may be greater than the driving time difference of the second driving part M2.

Accordingly, in the present specification, the first maximum speed and the second maximum speed are maximum instantaneous speeds. In addition, the maximum speed is an angle, moving angle, or distance moved in the direction perpendicular to the optical axis direction over time In addition, the moving angle and a movement amount are used interchangeably with the same meaning hereinafter.

In addition, the first driving part M1 may be a VCM. In addition, the second driving part M2 may be a piezo type actuator which has a higher maximum instantaneous speed than the VCM and uses a piezoelectric force.

Alternatively, the first driving part M1 may be a VCM. In addition, the second driving part M2 may be a shape-memory alloy (SMA) type actuator which has a higher maximum instantaneous speed than the VCM.

Alternatively, the first driving part M1 may be a VCM. In addition, the second driving part M2 may be an actuator which has a higher maximum instantaneous speed than the VCM and provides interface changes in a liquid lens.

Alternatively, the first driving part M1 may be an SMA type actuator. In addition, the second driving part M2 may be a piezo type actuator which has a higher maximum instantaneous speed than the SMA type actuator and uses a piezoelectric force.

Alternatively, the first driving part M1 may be an actuator which provides interface changes in a liquid lens. In addition, the second driving part M2 may be a piezo type actuator which has a higher maximum instantaneous speed than the first driving part M1 and uses a piezoelectric force.

Alternatively, the first driving part M1 may be an actuator which provides interface changes in a liquid lens. In addition, the second driving part M2 may be a piezo type actuator which has a higher maximum instantaneous speed than the first driving part M1 and uses a piezoelectric force.

Alternatively, the first driving part M1 may be a VCM. In addition, the second driving part M2 may be an SMA type actuator which has a higher maximum instantaneous speed than the VCM. Additional embodiments will be described below.

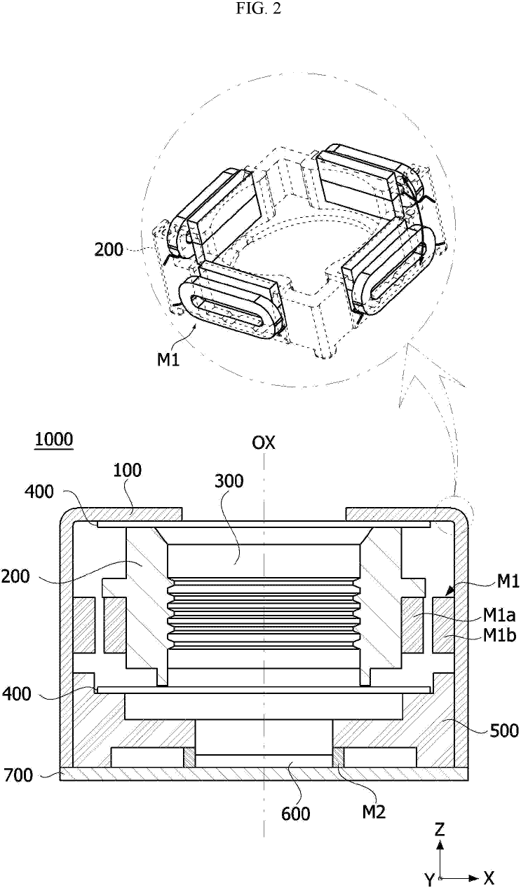

Referring to FIG. 1B, in the first example of the camera module, the above-described content may be equally applied to a fixed part G1, a moving part G2, a first driving part M1, and a second driving part M2 aside from content which will be described below. In addition, a lens part, an image sensor, and an optical member may correspond to a lens part, an image sensor, and an optical member which will be described with reference to FIG. 2.

In the first example of the camera module, the first driving part M1 and the second driving part M2 may be connected to each other. In addition, the second driving part M2 may be connected to the moving part G2. In addition, the first driving part M1 and the second driving part M2 may be connected to the same moving part G2 and may move the same moving part G2. Particularly, the second driving part M2 may be connected to a lens part LS of the moving part G2. Accordingly, the lens part LS may be moved in the optical axis direction or a direction perpendicular to the optical axis direction or tilted by the second driving part M2.

In addition, the first driving part M1 may be disposed between the second driving part M2 and the fixed part G1. In addition, the first driving part M1 may be connected to the second driving part M2 and may move the second driving part M2 and the lens part LS. Accordingly, the lens part LS may also be moved in the optical axis direction or the direction perpendicular to the optical axis direction or tilted by the first driving part M1.

Referring to FIG. 1C, in the second example of the camera module, the above-described content may be equally applied to a fixed part G1, a moving part G2, a first driving part M1, and a second driving part M2 aside from content which will be described below.

In the second example of the camera module, the first driving part M1 and the second driving part M2 may be connected to each other. In addition, the second driving part M2 may be connected to the moving part G2. In addition, the first driving part M1 and the second driving part M2 may be connected to the same moving part G2 and may move the moving part G2. Particularly, the second driving part M2 may be connected to an image sensor IS of the moving part G2. Accordingly, the image sensor IS may be moved in an optical axis direction or a direction perpendicular to the optical axis direction or tilted by the second driving part M2.

In addition, the first driving part M1 may be disposed between the second driving part M2 and the fixed part G1. In addition, the first driving part M1 may be connected to the second driving part M2 and may move the second driving part M2 and the image sensor IS. Accordingly, the image sensor IS may also be moved in the optical axis direction or the direction perpendicular to the optical axis direction or tilted by the first driving part M1.

Referring to FIG. 1D, in the third example of the camera module, the above-described content may be equally applied to a fixed part G1, a moving part G2, a first driving part M1, and a second driving part M2 aside from content which will be described below.

In the third example of the camera module, the first driving part M1 and the second driving part M2 may be connected to different components of a moving part. Particularly, the first driving part M1 may be connected to a lens part LS of the moving part G2 and may move the lens part LS in an optical axis direction or a direction perpendicular to the optical axis direction or tilt the lens part LS. In addition, the first driving part M1 may be positioned between the fixed part G1 and the lens part LS and connected to the fixed part G1 and the lens part LS.

In addition, the second driving part M2 may be connected to an image sensor IS of the moving part G2 and may move the image sensor IS in the optical axis direction or the direction perpendicular to the optical axis direction or tilt the image sensor IS. In addition, the second driving part M2 may also be positioned between the fixed part G1 and the image sensor IS. Accordingly, the second driving part M2 may be connected to the fixed part G1 and the image sensor IS.

Referring to FIG. 1E, in the fourth example of the camera module, the above-described content may be equally applied to a fixed part G1, a moving part G2, a first driving part M1, and a second driving part M2 aside from content which will be described below.

In the fourth example of the camera module, the first driving part M1 and the second driving part M2 may be connected to different components of a moving part. Particularly, the first driving part M1 may be connected to an image sensor IS of the moving part G2 and may move the image sensor IS in an optical axis direction or a direction perpendicular to the optical axis direction or tilt the image sensor IS. In addition, the first driving part M1 may be positioned between the fixed part G1 and the image sensor IS and connected to the fixed part G1 and the image sensor IS,

In addition, the second driving part M2 may be connected to a lens part LS of the moving part G2 and may move the lens part LS in the optical axis direction or the direction perpendicular to the optical axis direction or tilt the lens part LS. In addition, the second driving part M2 may also be positioned between the fixed part G1 and the lens part LS. Accordingly, the second driving part M2 may be connected to the fixed part G1 and the lens part LS.

Referring to FIG. 1F, in the fifth example of the camera module, the above-described content may be equally applied to a fixed part G1, a moving part G2, a first driving part M1, and a second driving part M2 aside from content which will be described below.

In the fifth example of the camera module, the first driving part M1 and the second driving part M2 may be connected to each other. In addition, the second driving part M2 may be connected to the moving part G2. In addition, the first driving part M1 and the second driving part M2 may move the same moving part (for example, an optical member OE, a lens part LS, or an image sensor IS). The optical member OE may include an optical member OE for changing an optical path. For example, the optical member OE for changing the optical path may include a prism, a mirror, or the like.

Particularly, the second driving part M2 may be connected to the optical member OE of the moving part G2. Accordingly, the optical member OE may be moved in an optical axis direction or a direction perpendicular to the optical axis direction or tilted by the second driving part M2. The optical member OE may include various optical elements which change the optical path. This will be described in detail below.

In addition, the first driving part M1 may be disposed between the second driving part M2 and the fixed part G1. In addition, the first driving part M1 may be connected to the second driving part M2 and may move or tilt the second driving part M2 and the optical member OE. Accordingly, the optical member OE may also be moved in the optical axis direction or the direction perpendicular to the optical axis direction or tilted by the first driving part M1.

Referring to FIG. 1G, in the sixth example of the camera module, the above-described content may be equally applied to a fixed part G1, a moving part G2, a first driving part M1, and a second driving part M2 aside from content which will be described below.

In the sixth example of the camera module, the first driving part M1 and the second driving part M2 may be connected to each other. In addition, the second driving part M2 may be connected to the moving part G2. In addition, the first driving part M1 and the second driving part M2 may move the same moving part (for example, an optical member OE, a lens part LS, or an image sensor IS).

Particularly, the second driving part M2 may be connected to the lens part LS of the moving part G2. Accordingly, the lens part LS may be moved in an optical axis direction or a direction perpendicular to the optical axis direction or tilted by the second driving part M2.

In addition, the first driving part M1 may be disposed between the second driving part M2 and the fixed part G1. In addition, the first driving part M1 may be connected to the second driving part M2 and may move the second driving part M2 and the lens part LS. Accordingly, the lens part LS may also be moved in the optical axis direction or the direction perpendicular to the optical axis direction or tilted by the first driving part M1.

Referring to FIG. 1H, in the seventh example of the camera module, the above-described content may be equally applied to a fixed part G1, a moving part G2, a first driving part M1, and a second driving part M2 aside from content which will be described below.

In the seventh example of the camera module, the first driving part M1 and the second driving part M2 may be connected to each other. In addition, the second driving part M2 may be connected to the moving part G2. In addition, the first driving part M1 and the second driving part M2 may move the same moving part (for example, an optical member OE, a lens part LS, or an image sensor IS.

Particularly, the second driving part M2 may be connected to the image sensor IS of the moving part G2. Accordingly, the image sensor IS may be moved in an optical axis direction or a direction perpendicular to the optical axis direction or tilted by the second driving part M2.

In addition, the first driving part M1 may be disposed between the second driving part M2 and the fixed part G1. In addition, the first driving part M1 may be connected to the second driving part M2 and may move the second driving part M2 and the image sensor IS. Accordingly, the image sensor IS may also be moved in the optical axis direction or the direction perpendicular to the optical axis direction or tilted by the first driving part M1.

Referring to FIG. 1I, in the eighth example of the camera module, the above-described content may be equally applied to a fixed part G1, a moving part G2, a first driving part M1, and a second driving part M2 aside from content which will be described below.

In the eighth example of the camera module, the first driving part M1 and the second driving part M2 may be connected to different components of a moving part. Particularly, the first driving part M1 may be connected to an optical member OE of the moving part G2 and may move the optical member OE in an optical axis direction or a direction perpendicular to the optical axis direction or tilt the optical member OE. In addition, the first driving part M1 may be positioned between the fixed part G1 and the optical member OE and connected to the fixed part G1 and the optical member OE.

In addition, the second driving part M2 may be connected to an image sensor IS of the moving part G2 and may move the image sensor IS in the optical axis direction or the direction perpendicular to the optical axis direction or tilt the image sensor IS. In addition, the second driving part M2 may also be positioned between the fixed part G1 and the image sensor IS. Accordingly, the second driving part M2 may be connected to the fixed part G1 and the image sensor IS.

Referring to FIG. 1J, in the ninth example of the camera module, the above-described content may be equally applied to a fixed part G1, a moving part G2, a first driving part M1, and a second driving part M2 aside from content which will be described below.

In the ninth example of the camera module, the first driving part M1 and the second driving part M2 may be connected to different components of a moving part. Particularly, the first driving part M1 may be connected to an image sensor IS of the moving part G2 and move the image sensor IS in an optical axis direction or a direction perpendicular to the optical axis direction or tilt the image sensor IS. In addition, the first driving part M1 may be positioned between the fixed part G1 and the image sensor IS and connected to the fixed part G1 and the image sensor IS.

In addition, the second driving part M2 may be connected to an optical member OE of the moving part G2 and may move the image sensor IS in the optical axis direction or the direction perpendicular to the optical axis direction or tilt the image sensor IS In addition, the second driving part M2 may also be positioned between the fixed part G1 and the optical member OE. Accordingly, the second driving part M2 may be connected to the fixed part G1 and the optical member OE.

Referring to FIG. 1K, in the tenth example of the camera module, the above-described content may be equally applied to a fixed part G1, a moving part G2, a first driving part M1, and a second driving part M2 aside from content which will be described below.

In the tenth example of the camera module, the first driving part M1 and the second driving part M2 may be connected to different components of a moving part. Particularly, the first driving part M1 may be connected to a lens part LS of the moving part G2 and may move the lens part LS in an optical axis direction or a direction perpendicular to the optical axis direction or tilt the lens part LS. In addition, the first driving part M1 may be positioned between the fixed part G1 and the lens part LS and connected to the fixed part G1 and the lens part LS.

In addition, the second driving part M2 may be connected to an image sensor IS of the moving part G2 and may move the image sensor IS in the optical axis direction or the direction perpendicular to the optical axis direction or tilt the image sensor IS. In addition, the second driving part M2 may also be positioned between the fixed part G1 and the image sensor IS. Accordingly, the second driving part M2 may be connected to the fixed part G1 and the image sensor IS.

Referring to FIG. 1L, in the eleventh example of the camera module, the above-described content may be equally applied to a fixed part G1, a moving part G2, a first driving part M1, and a second driving part M2 aside from content which will be described below.

In the eleventh example of the camera module, the first driving part M1 and the second driving part M2 may be connected to different components of a moving part. Particularly, the first driving part M1 may be connected to an image sensor IS of the moving part G2 and may move the image sensor IS in an optical axis direction or a direction perpendicular to the optical axis direction or tilt the image sensor IS. In addition, the first driving part M1 may be positioned between the fixed part G1 and the image sensor IS and connected to the fixed part G1 and the image sensor IS.

In addition, the second driving part M2 may be connected to a lens part LS of the moving part G2 and may move the lens part LS in the optical axis direction or the direction perpendicular to the optical axis direction or tilt the lens part LS. In addition, the second driving part M2 may also be positioned between the fixed part G1 and the lens part LS. Accordingly, the second driving part M2 may be connected to the fixed part G1and the lens part LS.

Referring to FIG. 1M, in the twelfth example of the camera module, the above-described content may be equally applied to a fixed part G1, a moving part G2, a first driving part M1, and a second driving part M2 aside from content which will be described below.

In the twelfth example of the camera module, the first driving part M1 and the second driving part M2 may be connected to different components of a moving part. Particularly, the first driving part M1 may be connected to an optical member OE of the moving part G2 and may move the optical member OE in an optical axis direction or a direction perpendicular to the optical axis direction or tilt the optical member OE. In addition, the first driving part M1 may be positioned between the fixed part G1 and the optical member OE and connected to the fixed part G1 and the optical member OE.

In addition, the second driving part M2 may be connected to a lens part LS of the moving part G2 and may move the lens part LS in the optical axis direction or the direction perpendicular to the optical axis direction or tilt the lens part LS. In addition, the second driving part M2 may also be positioned between the fixed part G1 and the lens part LS Accordingly, the second driving part M2 may be connected to the fixed part G1 and the lens part LS.

Referring to FIG. 1N, in the thirteenth example of the camera module, the above-described content may be equally applied to a fixed part G1, a moving part G2, a first driving part M1, and a second driving part M2 aside from content which will be described below.

In the thirteenth example of the camera module, the first driving part M1 and the second driving part M2 may be connected to different components of a moving part. Particularly, the first driving part M 1 may be connected to a lens part LS of the moving part G2 and may move the lens part LS in an optical axis direction or a direction perpendicular to the optical axis direction or tilt the lens part LS. In addition, the first driving part M1 may be positioned between the fixed part G1 and the lens part LS and connected to the fixed part G1 and the lens part LS.

In addition, the second driving part M2 may be connected to an optical member OE of the moving part G2 and may move the optical member OE in the optical axis direction or the direction perpendicular to the optical axis direction or tilt the optical member OE. In addition, the second driving part M2 may also be positioned between the fixed part G1 and the optical member OE. Accordingly, the second driving part M2 may be connected to the fixed part G1 and the optical member OE.

FIG. 2 is a configuration view illustrating a camera module according to a first embodiment.

Referring to FIG. 2, the camera module according to the first embodiment may include a housing 100, a lens part including a lens holder 200 and a lens assembly 300, elastic members 400, a base 500, an image sensor 600, a first driving part M1, and a second driving part M2.

The housing 100 may be positioned at an outermost side of a camera module 1000. The housing 100 may protect components from external foreign matters. In addition, the housing 100 may be formed of a material capable of protecting other components in the housing 100 from external electromagnetic waves. Accordingly, the reliability of the camera module can be improved.

The housing 100 may include a hole therein. The lens part, which will be described below, may be seated in the hole. The housing 100 and the lens part may be connected by the first driving part M1. The lens part may be moved in an optical axis OX (Z-axis) direction by the first driving part M1.

The present embodiment will be described based on the concept that the housing 100 and the lens part are connected by the first driving part M1 and the base 500 and the image sensor 600 are connected by the second driving part M2. However, in the present invention, the first driving part M1 and the second driving part M2 may move a moving part in a direction perpendicular to an optical axis (an X-axis or Y-axis direction) or in an optical axis direction (a Z-axis direction) or tilt the moving part, and at least a part of each of the first driving part M1 and the second driving part M2 may be connected to a fixed part. As described above, components of the moving part or the fixed part connected to the first driving part M1 and the second driving part M2 may be changed. Specific related embodiments will be described through a second embodiment to a modified embodiment which will be described below.

The lens part may be disposed in the hole of the housing 100. The lens part may include the lens holder 200 and the lens assembly 300.

The lens holder 200 may be seated in the hole in the housing 100. In addition, the lens holder 200 may include a hole. Particularly, the lens holder 200 may include the hole passing through the lens holder 200 in the optical axis direction. For example, an inner circumferential surface of the lens holder 200 may include a screw thread corresponding to a screw thread formed on an outer circumferential surface of the lens assembly 300. For example, various elements such as an elastic member (for example, a leaf spring), a guide part (for example, a ball) and a pin may be disposed between the lens holder 200 and the lens assembly 300, and thus the lens holder 200 and the lens assembly 300 may be easily coupled. Hereinafter, the coupling will be described based on the elastic members 400. In addition, description about such coupling may be equally applied to other fixed parts and moving parts.

The lens assembly 300 may be disposed in the hole of the lens holder 200. The lens assembly 300 may include a plurality of lenses. In addition, the plurality of lenses may include a fixed lens, of which a position is fixed, and a moving lens which moves in the optical axis direction. Alternatively, all the plurality of lenses may also be moving parts.

The elastic member 400 may be connected to the housing 100 and the lens holder 200. In the embodiment, the housing 100 and the lens holder 200 may be coupled to each other through the elastic member 400. The elastic member 400 and the housing 100, or the lens holder 200 and the elastic member 400 may be coupled by an adhesive or through thermal fusion. The adhesive may be formed of an epoxy to be cured by at least one among ultraviolet (UV) light, heat, and a laser.

In addition, the elastic member 400 may be disposed between the lens holder 200 and the base 500. Alternatively, the elastic member 400 may also be disposed between the housing 100 and the base 500.

The base 500 may be disposed in the housing 100. Alternatively, the base 500 may be positioned in a lower portion of the housing 100. The base 500 may include a hole in the optical axis direction. The hole of the base 500 may overlap the lens assembly 300 in the optical axis direction.

The base 500 may be coupled to the lens holder 200 through the elastic member 400. In addition, the elastic member 400 and the lens holder 200, or the base 500 and the elastic member 400 may be coupled by an adhesive or through thermal fusion. The adhesive may be formed of an epoxy to be cured by at least one among UV light, heat, and a laser.

The image sensor 600 may be positioned in the hole of the base 500. The image sensor 600 may be disposed at a position corresponding to the lens assembly 300. The image sensor 600 may be disposed on a substrate 700 along with the base 500. In this case, the camera module may further include the substrate 700.

The image sensor 600 may be electrically connected to the substrate 700. The image sensor 600 may be coupled to the substrate 700 in a flip chip manner. The image sensor 600 may be coupled to the substrate 700 through wiring, soldering, or the like.

In addition, the image sensor 600 may be disposed to have the same optical axis as the lens. That is, the optical axis of the image sensor 600 may be aligned with the optical axis of the lens. The image sensor 600 may convert light incident on an effective imaging region of the image sensor 600 into an electric signal. For example, the image sensor 600 may be any one among a charge coupled device (CCD) sensor, a metal-oxide-semiconductor (MOS) sensor, a carbon-based polymer dot (CPD) sensor, and a charge-injection device (CID) sensor.

The substrate 700 may be a printed circuit board The substrate 700 may be electrically connected to a control unit (not shown) of a mobile terminal.

The first driving part M1 may be disposed between the fixed part G1 and the moving part G2. In the embodiment, the first driving part M1 may be disposed between the housing 100 and the lens holder 200. The first driving part M1 may include a coil M1a and a magnet M1b. The coil M1a and the magnet M1b may be disposed on the lens holder 200 and the housing 100, respectively, to face each other. Accordingly, the lens holder 200 may move relative to the housing 100 in a direction perpendicular to the optical axis direction or in the optical axis direction or may tilt. For example, the first driving part M1 may be a VCM. The first driving part M1 may be provided as a plurality of first driving parts M1.

The second driving part M2 may be disposed between the fixed part G1 and the moving part G2. In addition, the second driving part M2 may be disposed between the first driving part M1 and the moving part G2. For example, the second driving part M2 may be disposed between the first driving part M1 and the lens holder 200. The second driving part M2 may be a piezo type actuator driven by a piezoelectric force. The second driving part M2 may move the lens holder 200 relative to the housing 100 in the direction perpendicular to the optical axis or in the optical axis direction or tilt the lens holder 200 by adjusting a size of the second driving part M2. That is, the moving part G2 may be moved in at least one direction among three directions perpendicular to each other or tilted by each of the first driving part M1 and the second driving part M2.

In the camera module according to the embodiment, the first driving part M1 and the second driving part M2 may be connected to each other Accordingly, when the first driving part M1 moves the moving part at a first moving angle, the second driving part M2 may move the moving part at a second moving angle to disperse a movement amount and reduce vibration. Accordingly, the reliability of the camera module can also be improved.

In the camera module according to the embodiment, the first driving part M1 may drive or move (move in parallel, tilt, or the like) the second driving part M2 and the moving part G2 together, and the second driving part M2 may drive or move (move in parallel, tilt, or the like) the moving part G2.

In the camera module according to the embodiment, the second driving part M2 may drive or move (move in parallel, tilt, or the like) the first driving part M1 and the moving part G2 together, and the first driving part M1 may drive or move (move in parallel, tilt, or the like) the moving part G2.

In addition, the camera module 1000 according to the embodiment may include a controller (not shown) or a position sensor (for example, a gyro sensor). The controller may be disposed on the substrate 700. Alternatively, the controller may be positioned outside the substrate 700. The controller may individually control a direction, an intensity, and an amplitude of a current supplied for driving the first driving part M1 and the second driving part M2. The controller may perform an OIS function by controlling the first driving part M1 and the second driving part M2. In addition, the controller may also supply a current to a driving part which performs an AF function to perform AF. In addition, the controller may perform AF feedback control and/or OIS feedback control for a lens driving device.

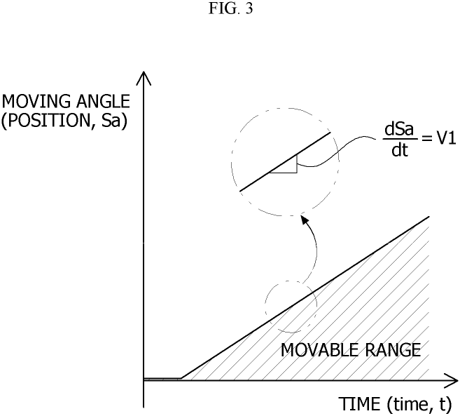

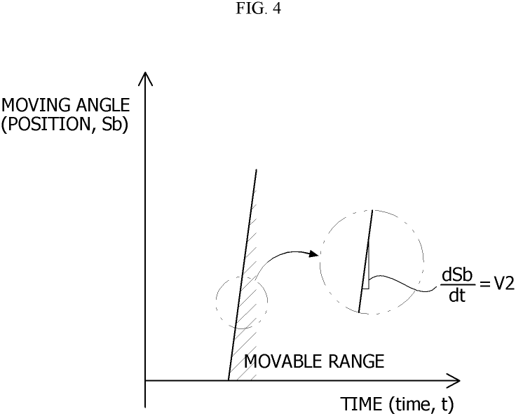

FIG. 3 is a view for describing the first driving part according to the embodiment, and FIG. 4 is a view for describing the second driving part according to the embodiment.

Referring to FIGS. 3 and 4, in the embodiment, the first driving part M1 may move the lens holder 200 at a first maximum speed V1 or lower, and the second driving part M2 may move the image sensor 600 at a second maximum speed V2 or lower.

Accordingly, the second driving part M2 may provide a larger moving angle (or movement amount) than the first driving part M1 for a certain time. In the present specification, the moving angle (or movement amount) denotes a tilting angle of the moving part with respect to an X-axis or Y-axis of which a direction is perpendicular to the optical axis (Z-axis) or an extent of movement (for example, along the X-axis, Y-axis, or Z-axis) of the driving part by the first and second driving parts. In addition, the maximum speed may be an angular speed.

In addition, since the second maximum speed V2 is higher than the first maximum speed V1, the second driving part M2 may provide a speed range (corresponding to an operational range) wider than a speed range provided by the first driving part M1. That is, the speed range in which the moving part is allowed to be moved by the second driving part M2 is wider than the speed range in which the moving part is allowed to be moved by the first driving part M1. In addition, the speed range in which the moving part is allowed to be moved by the second driving part M2 may include the speed range in which the moving part is allowed to be moved by the first driving part M1. However, the opposite case may also be implemented.

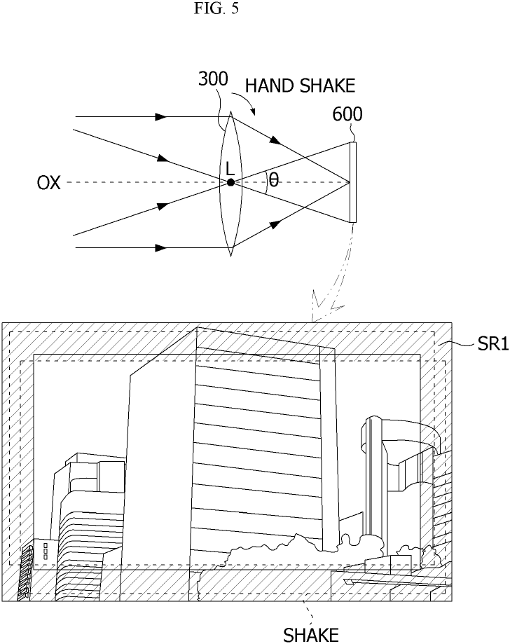

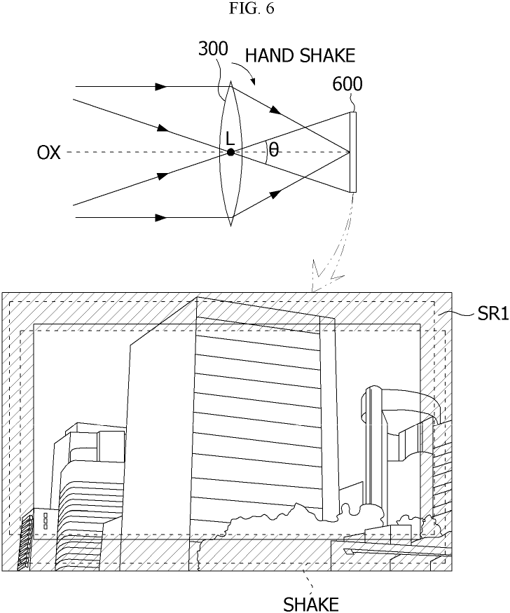

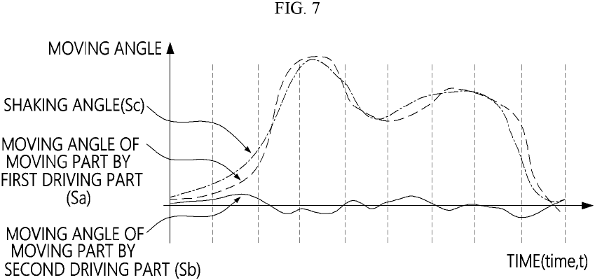

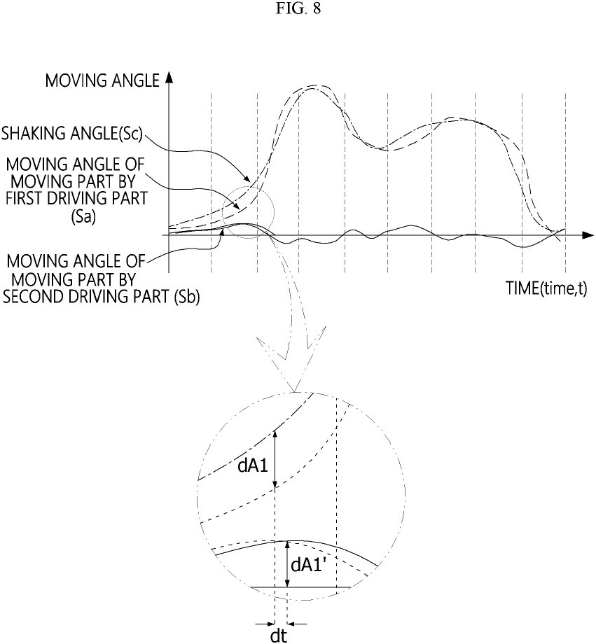

FIGS. 5 and 6 are views for describing an operation of performing OIS according to a field of view of the camera module according to the embodiment FIG. 7 is a view for describing a change in movement angle for the OIS of the camera module according to the embodiment, and FIG. 8 is a view for describing a change in movement angle for OIS of a camera module according to another embodiment. Hereinafter, a focal length, a field of view, and an OIS operation will be described using the lens assembly 300 and the image sensor 600 of the camera module described with reference to FIGS. 5 and 6.

Referring to FIGS. 5 and 6, the focal length, the field of view, and the OIS operation will be described with reference to FIG. 5 showing a wide angle state and FIG. 6 showing a telephoto state.

A focal length L of the lens assembly 300 and the image sensor 600 in the wide angle state may be greater than a focal length L′ of the lens assembly 300 and the image sensor 600 in the telephoto state.

In addition, a field of view θ of the lens assembly 300 and the image sensor 600 in the wide angle state may be smaller than a field of view θ′ of the lens assembly 300 and the image sensor 600 in the telephoto state.

In addition, in the wide angle state, when the lens assembly 300 is shaken by a hand shake of a user, an image formed on the image sensor 600 may have a first shaken region SR1 with respect to an entire size or area of the image sensor 600.

In the telephoto state, when the lens assembly 300 is shaken by a hand shake of the user, an image formed on the image sensor 600 may have a second shaken region SR2 with respect to the entire size or area of the image sensor 600.

When the hand shake of the user is the same (for example, when shaken at a certain shaking angle), the first shaken region SR1 may be smaller than the second shaken region SR2. In other words, as the field of view decreases, the shaken region caused by the hand shake may increase.

In this case, the shaken region may be a region in which images are formed to overlap and an image is not formed on the image sensor due to the hand shake or shake caused by the hand shake. That is, a region inside the shaken region in the drawing is a region in which an image is formed even when the hand shake or the shake caused by the hand shake occurs.

In addition, when the hand shake of the user is the same, and the field of view is small, an image of a smaller region is output compared to the case of a large field of view, and an amount of shake caused by the hand shake may be larger compared to the case of the large field of view. That is, when the hand shake of the user is the same, an amount of movement of a center of an image moved due to the shake may be relatively smaller in the case of the larger field of view than in the case of the small field of view. Accordingly, when an extent of the hand shake is the same, a suppression ratio in the case of the small field of view may increase from that in the case of the large field of view.

Accordingly, as described above, the camera module according to the embodiment may use the first driving part and the second driving part having different instantaneous speeds to provide an improved suppression ratio and reduce a size of the entire camera module even when the field of view decreases compared to a case in which one driving part is used. In this case, the suppression ratio satisfies Equation 1 below.

$$\text{Suppression} \text{Ratio} = - 20 \left(\text{onpixels} / \text{offpixels}\right)$$

In this case, onpixels is the number of pixels shaken when OIS is performed, and offpixels is the number of pixels shaken when the OIS is not performed.

More specifically, referring to FIG. 7, in the camera module according to the embodiment, the first driving part may move the moving part to correspond to a shaking angle. In this case, the shaking angle may denote an angle at which the camera module or the moving part is moved due to a hand shake of the user or an angle corresponding to a distance that the camera module or the moving part is moved. The shaking angle is provided from the position sensor (for example, the gyro sensor) positioned inside or outside the camera module.

In addition, in the camera module, the second driving part may move the moving part to compensate for a difference between a moving angle (for example, the first moving angle) caused by the first driving part and the shaking angle.

That is, when shaking occurs, the camera module according to the embodiment may correct the shaking at a large angle using the first driving part. In this case, there may be an error with respect to the actual shaking. Accordingly, the camera module may more accurately correct the shaking by compensating for the error using the second driving part at the same time or a different time after the first driving part compensates for the shaking

In the embodiment, the second driving part and the first driving part may operate at the same time. In the embodiment, in the camera module, the first driving part and the second driving part may move the moving part using a lookup table in which control signal information for moving the moving part to a predetermined position is stored. Accordingly, the first driving part and the second driving part may receive a digital code for each angle of the moving part or a control signal corresponding to the angle (or digital code). In addition, the moving part may be moved by the first driving part and the second driving part. That is, the first driving part and the second driving part may move the driving part at the first moving angle and the second moving angle at the same time to correspond to a certain shaking angle. Using such a structure, even when the lens assembly or the like shakes, the camera module according to the embodiment can perform OIS with an improved suppression ratio against the shaking.

Referring to FIG. 8, in a camera module according to another embodiment, a first driving part may move a moving part to correspond to a shaking angle as described above. In addition, in the camera module, a second driving part may move the moving part at a specific moving angle (for example, a second moving angle) to compensate for a difference between a moving angle (for example, the first moving angle) caused by the first driving part and the shaking angle.

The camera module according to another embodiment may correct shaking by compensating for the above-described error using the second driving part at a time different from after the first driving part moves the moving part. Accordingly, the camera module according to another embodiment can perform OIS more accurately.

In the embodiment, in the camera module, there may be a time difference dt between an error dA1 between a moving angle caused by the first driving part and a shaking angle and a moving angle dA1′ caused by the second driving part to correspond to the error. That is, the camera module may calculate the error dA1 between the first driving part and the shaking angle and control a moving angle using the second driving part to compensate for the error dA1between the first driving part and the shaking angle. Using such a structure, even when the lens assembly and the like are shaken, the camera module according to another embodiment can compensate for shaking and provide a more improved suppression ratio.

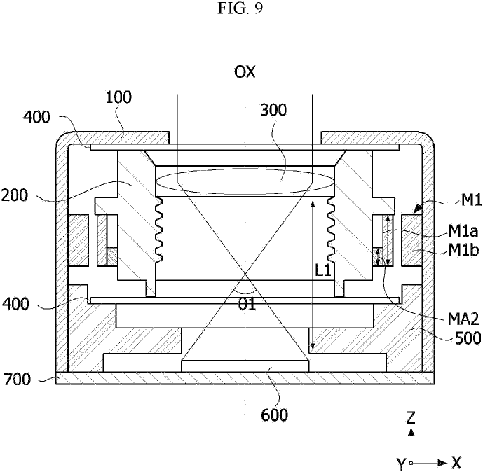

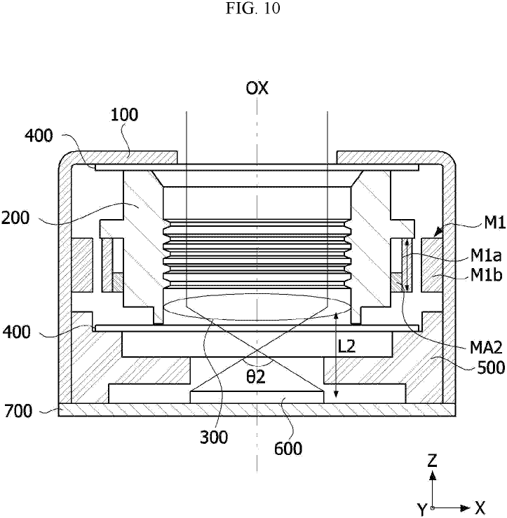

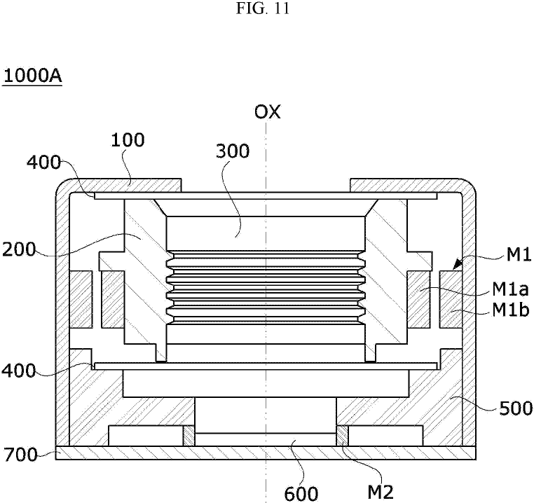

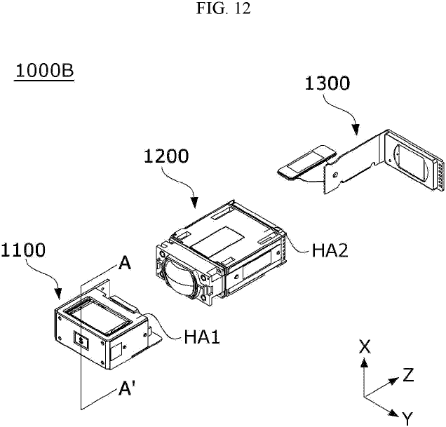

FIGS. 9 and 10 are views for describing an OIS operation of a camera module according to a modified embodiment of FIG. 2.

Referring to FIGS. 9 and 10, the camera module according to the modified embodiment may change control of a moving part controlled by a second driving part according to a focal length.

First, as in FIG. 9, due to movement of the moving part, a focal length L1 may become long, and a field of view θ1 may become small. In this case, when the camera module according to the modified embodiment performs OIS, the camera module may move the moving part using a first driving part and the second driving part

In addition, as in FIG. 10, due to movement of the moving part, a focal length L2 may become small, and a field of view θ2 may become large. In this case, when the camera module according to the modified embodiment performs OIS, the camera module may move the moving part using the first driving part.

That is, the camera module according to the modified embodiment may selectively control the first driving part and the second driving part according to a focal length. That is, when the focal length is greater than a first threshold, the camera module may move the moving part using the first driving part and the second driving part. In contrast, when the focal length is smaller than the first threshold, only the first driving part may be selectively controlled to move the moving part.

In addition, the camera module according to the modified embodiment may control only the second driving part when the focal length is smaller than a second threshold. The second threshold may be smaller than the first threshold. In other words, when the focal length is smaller than the first threshold and greater than the second threshold, the moving part may be moved by the first driving part, and when the focal length is smaller than the second threshold, the moving part may be moved by the second driving part.

Alternatively, according to the focal length, the camera module according to the modified embodiment may apply control signals to the first driving part and the second driving part corresponding to the focal length. For example, when the focal length increases, an amplitude of the signal applied to the second driving part may be increased. Accordingly, a movement amount that the moving part is moved by the second driving part may be greater than a movement amount that the moving part is moved by the first driving part. In addition, when the focal length decreases, an amplitude of the signal applied to the first driving part may be increased. Accordingly, a movement amount that the moving part is moved by the first driving part may be greater than a movement amount that the moving part is moved by the second driving part. However, the opposite case may also be implemented.

FIG. 11 is a configuration view illustrating a camera module according to a second embodiment.

Referring to FIG. 11, a camera module 1000A according to the second embodiment may include a housing 100, a lens part including a lens holder 200 and a lens assembly 300, elastic members 400, a base 500, an image sensor 600, a first driving part M1, and a second driving part M2.

The lens part and the image sensor 600 which are moving parts may be moved by the first driving part M1 and the second driving part M2.

In addition, the first driving part M1 and the second driving part M2 may move the moving parts according to the various embodiments described above, and the above-described content may be equally applied to the second embodiment aside from the following content.

The first driving part M1 may be positioned on the base 500 or in the housing 100. In addition, the first driving part M1 may be disposed between the lens part which is the moving part and a fixed part.

In addition, the second driving part M2 may be positioned between the fixed part and the moving part and disposed apart from the first driving part M1. That is, the first driving part M1 and the second driving part M2 may be connected to different fixed parts and different moving parts. In addition, the first driving part M1 and the second driving part M2 may be disposed between the different fixed parts and the different moving parts and move the different moving parts.

In the camera module according to the embodiment, the first driving part M1 may be disposed between the lens part 200 and 300, of the fixed part and the housing 100, and the second driving part M2 may be disposed between the base 500 and the image sensor 600.

Alternatively, in the camera module, the first driving part M1 may be disposed between the base 500 of the fixed part and the image sensor 600 of the moving part, and the second driving part M2 may be disposed between the lens part 200 and 300, of the fixed part and the housing 100 of the moving part.

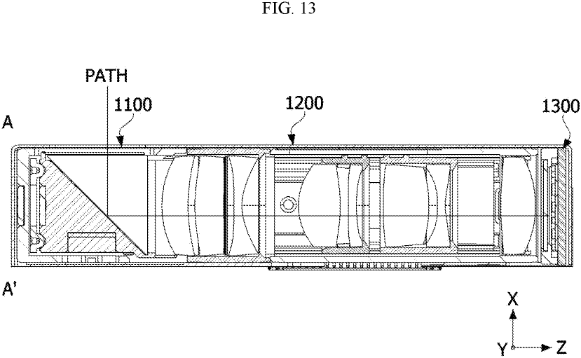

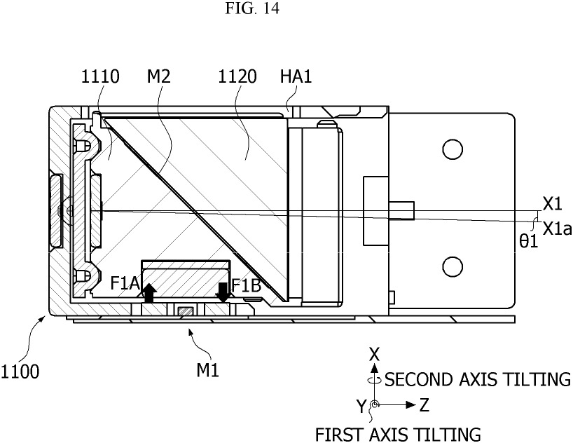

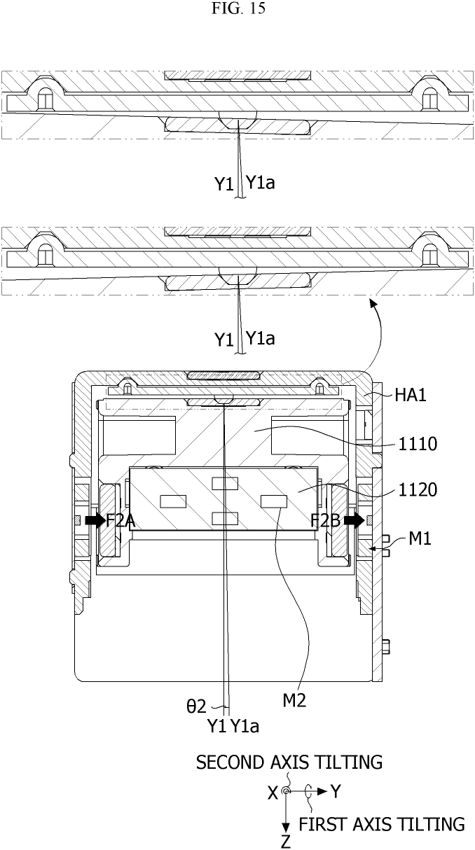

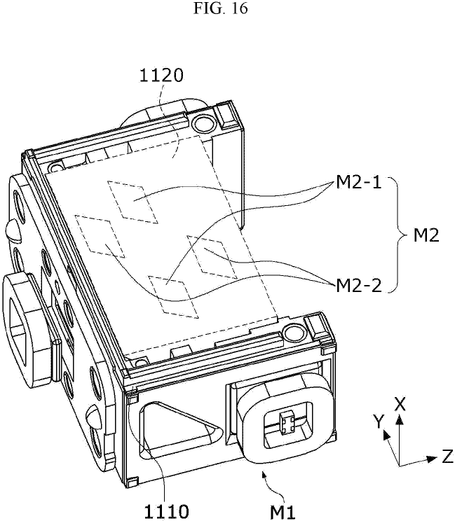

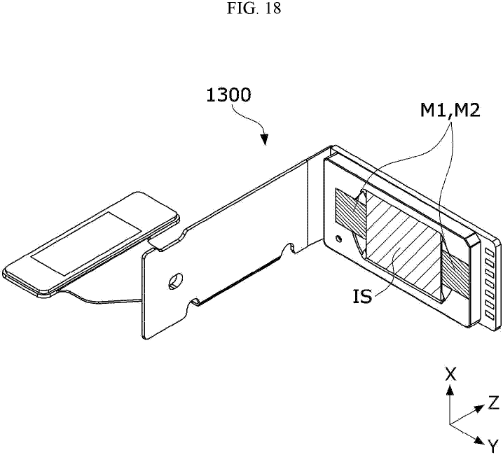

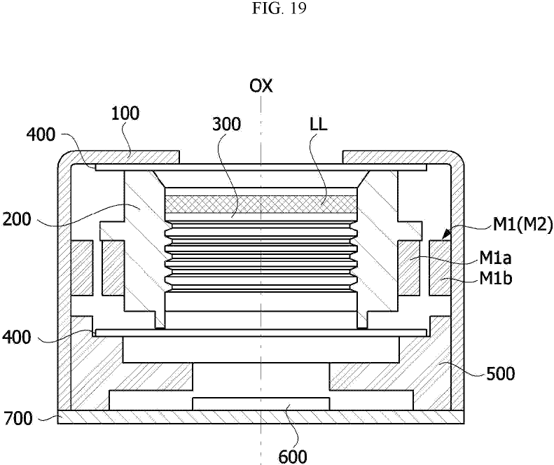

FIG. 12 is a configuration view illustrating a camera module according to a third embodiment. FIG. 13 is a cross-sectional view along line AA′ in FIG. 12. FIGS. 14 to 16 are views for describing OIS of a first camera actuator of the camera module according to the third embodiment. FIG. 17 is a view for describing OIS of a second camera actuator of the camera module according to the third embodiment. FIG. 18 is a view for describing OIS using an image sensor of the camera module according to the third embodiment.

Referring to FIG. 12, a camera module 1200B according to the third embodiment may include a first camera actuator 1100, a second camera actuator 1200, and a circuit substrate 1300. In this case, the first camera actuator 1100 may be interchangeably used with a first actuator, and the second camera actuator 1200 may be interchangeably used with a second actuator.

In the camera module according to the third embodiment, a moving part in the first camera actuator 1100 may include a holder and an optical member which actually move. In addition, a fixed part in the first camera actuator may be a first actuator housing HA1 surrounding the holder and the optical member.

In addition, in the camera module according to the third embodiment, moving parts in the second camera actuator 1200 may include a lens part including a lens assembly and a bobbin. In addition, a fixed part in the second camera actuator 1200 may be a second actuator housing HA2 surrounding the lens parts.

Specifically, the first camera actuator 1100 may be an OIS actuator.

The first camera actuator 1100 may include a fixed focal length lens disposed in a predetermined body tube (not shown). The fixed focal length lens may be referred to as a “single focal length lens” or “single lens.”

The first camera actuator 1100 may change an optical path. In the embodiment, the first camera actuator 1100 may vertically change the optical path using an optical member 1120 (for example, a mirror or prism) therein. The optical member may include various optical elements which vertically change an optical path. For example, the optical member which changes an optical path may include an angular prism, a mirror having a reflecting surface, or the like. The optical path may be changed by the optical member which changes an optical path. For example, a direction of an optical path passing through the optical member which changes the optical path may be vertically changed so that an angle between a center of incident light incident on the optical member which changes the optical path and a center of output light output from the optical member which changes the optical path is 90 degrees. Using such a structure, even when a thickness of a mobile terminal decreases, by changing the optical path, a lens structure greater than the thickness of the mobile terminal can be disposed in the mobile terminal, and thus magnification, AF, and OIS functions can be easily performed.

The second camera actuator 1200 may be disposed behind the first camera actuator 1100. The second camera actuator 1200 may be coupled to the first camera actuator 1100. In addition, the coupling therebetween may be implemented in various manners.

In addition, the second camera actuator 1200 may be a zoom actuator, an AF actuator, or an OIS actuator. For example, the second camera actuator 1200 may support one or a plurality of lenses and move the one or the plurality of lenses according to a control signal of a predetermined control unit to perform an AF, zoom, or OIS function.

The circuit substrate 1300 may be disposed behind the second camera actuator 1200. The circuit substrate 1300 may be connected to the second camera actuator 1200 and the first camera actuator 1100. In addition, the circuit substrate 1300 may be provided as a plurality of circuit substrates 1300. In addition, the circuit substrate 1300 may include an image sensor IS. The image sensor IS may be positioned to overlap a lens part 1210 in the second camera actuator 1200 in an optical axis direction.

The image sensor IS may be the fixed part or the moving part, and when the image sensor IS is the moving part, the image sensor IS may be moved or driven by a first driving part M1 and a second driving part M2 or by one driving part of both the first driving part M1 and the second driving part M2. The movement or driving may include movement or driving of parallel movement in a direction perpendicular or parallel to the optical axis and tilting. The above-described content may be equally applied to descriptions of the first driving part M1 and the second driving part M2.

In addition, the camera module according to the third embodiment may be provided as a single camera module or a plurality of camera modules. For example, the plurality of camera modules may include a first camera module and a second camera module.

In addition, the first camera module may include a single actuator or a plurality of actuators. For example, the first camera module may include the first camera actuator 1100 and the second camera actuator 1200.

In addition, the second camera module may include an actuator (not shown) which is disposed in a predetermined housing (not shown) and is capable of driving a lens part. The actuator may include various actuators as described above. For example, the actuator may be a VCM actuator, a micro actuator, a silicon actuator, or the like, various types such as a capacitance type, a thermal type, a bimorph type, an electrostatic force type may be applied thereto, and the present invention is not limited thereto. In addition, in the present specification, the camera actuator may be referred to as an actuator or the like. In addition, the camera module provided as the plurality of camera modules may be installed in an electronic device such as a mobile terminal.

Referring to FIG. 13, the camera module according to the embodiment may include the first camera actuator 1100 which performs an OIS function and the second camera actuator 1200 which performs a zooming function and an AF function or an OIS function.

Light may enter the camera module through an open region positioned in an upper surface of the first camera actuator 1100. That is, the light enters the first camera actuator 1100 in an optical axis direction (for example, an X-axis direction), and an optical path may be changed in a perpendicular direction (for example, a Z-axis direction) through the optical member of the first camera actuator 1100. In addition, the light may pass through the second camera actuator 1200 and may be incident on the image sensor IS on the circuit substrate 1300 positioned at one end of the second camera actuator 1200 (PATH).

In the present specification, in addition, a first direction may be the X-axis direction in the drawing, may correspond to the optical axis direction before the optical path is changed in the first camera actuator, and may be interchangeably used with a second axis direction or the like. A second direction may be a Y-axis direction in the drawing and may be interchangeably used with a first axis direction or the like. The second direction is a direction perpendicular to the first direction. In addition, a third direction may be the Z-axis direction on the drawing and may be interchangeably used with a third axis direction or the like The third direction is a direction perpendicular to both the first direction and the second direction. In this case, the third direction (Z-axis direction) corresponds to a direction of the optical axis after the optical path is changed in the optical member, and the first direction (X-axis direction) and the second direction (Y-axis direction) may be directions perpendicular to the optical axis and may be tilted by the second camera actuator. Details thereof will be described below. In addition, in the description of the second camera actuator 1200, the optical axis direction is the third direction (Z-axis direction) in which light is incident on the image sensor, and the second camera actuator 1200 will be described based thereon.

Using such a structure, the camera module according to the embodiment may change an optical path to improve a spatial limitation of the first camera actuator and the second camera actuator. That is, in the camera module according to the embodiment, as the optical path is changed, a thickness of the camera module is minimized, and the optical path may extend. In addition, it should be understood that the second camera actuator can provide a wide range of magnification by controlling a focal point and the like on the extended optical path.

In addition, the camera module according to the embodiment may control the optical path to implement OIS using the first camera actuator (for example, first and second driving parts), and thus occurrence of a decent or shaking phenomenon can be minimized, and best optical properties can be implemented.

In addition, the second camera actuator 1200 may include an optical system and the driving part (for example, the first and second driving parts). For example, at least one among a first lens assembly, a second lens assembly, a third lens assembly, and a guide pin may be disposed in the second camera actuator 1200.

In addition, the second camera actuator 1200 may include a coil and a magnet and perform a high-magnification zooming function or OIS function.

For example, in the second camera actuator 1200, each of the first lens assembly and the second lens assembly may be a moving lens which is moved by a coil, a magnet, and a guide pin, and the third lens assembly may be a fixed lens, but the present invention is not limited thereto. For example, one of the first to third lens assemblies may perform a focal point adjustment function to collect light at a specific position, and another of the first to third lens assemblies may perform a magnification changing function to adjust a magnification. For example, an image point at which an image is formed in the first lens assembly which performs the magnification changing function may slightly vary according to a position. In order to correct this, the second lens assembly may perform a function to adjust a position of a focal point for the formed image. For example, the second lens assembly may perform a function of a compensator which serves a focal point adjustment function to accurately position the image point, at which the image is formed in the first lens assembly, at a position of the actual image sensor. For example, each of the first lens assembly and the second lens assembly may be driven by an electromagnetic force caused by an interaction between the coil and the magnet. Accordingly, an AF or OIS function can be performed.

In the present specification, the OIS may also be referred to by terms such as hand shake correction, OIS, optical image correction, and shaking correction.

Referring to FIG. 14, an optical member 1120 for changing an optical path may be moved or tilted. For example, the optical member for changing an optical path may be tilted, rotationally moved, or driven. For example, the optical member may be driven or rotated in the first direction (X-axis direction) to implement OIS The optical member 1120 for changing an optical path may include a prism (for example, an angular prism or triangular column-shaped prism), a mirror (optical member having a reflecting surface and a flat plate shape), or the like, but is not limited thereto, and any optical member capable of changing and outputting a path of an overall light bundle of incident light may be included therein.

In the embodiment, the magnet disposed under a holder 1110, along with the coil facing the magnet, may generate an electromagnetic force and move or drive (for example, move in parallel, tilt, or rotationally move) the holder 1110 and the optical member 1120 for changing an optical path. The magnet and the coil may be the first driving part M1. As described above, the optical member 1120 for changing an optical path may serve as a moving part, and the optical member 1120 for changing an optical path may also be moved or driven by the first driving part M1 and the second driving part M2.

Specifically, the first actuator housing HA1 may be coupled to the holder 1110 and the optical member 1120 for changing an optical path. In addition, the holder 1110 and the optical member 1120 for changing an optical path may be supported by the first actuator housing HA1 in the first direction (X-axis direction). In addition, Y-axis tilting of the holder 1110 in the first actuator housing 1120 may be performed by the coil and the magnet based on a protrusion corresponding to a reference axis.

For example, the holder 1110 and the optical member 1120 for changing an optical path may be rotated at a first angle θ1 (X1 → X1a) in an X-axis direction by first electromagnetic forces F1A and FIB between the magnet and the coil to implement OIS. The first angle θ1 may be in the range of ±1° to 3°. However, the present invention is not limited thereto.

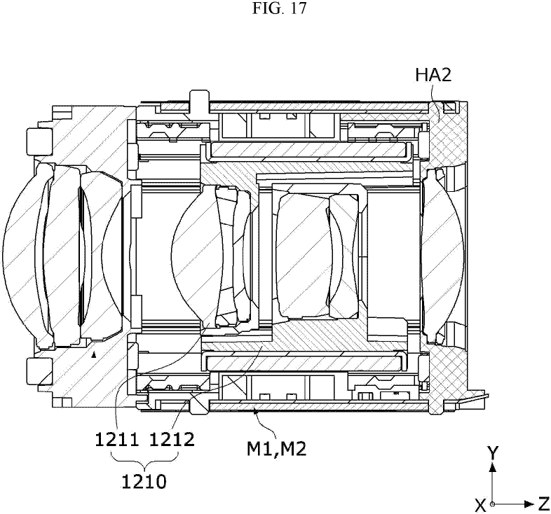

Referring to FIG. 15, X-axis tilting may be performed. That is, rotation in the second direction (Y-axis direction) may be performed to implement OIS.

The holder 1110 and the optical member 1120 for changing an optical path may tilt or rotate in the Y-axis direction (X-axis tilting) to implement the OIS.

In the embodiment, when an electromagnetic force is generated between the magnet and the coil disposed on a side portion of the first actuator housing 1110, a rotating plate 1141, the holder 1110, and the optical member 1120 for changing an optical path may be tilted or rotated in the second direction (Y-axis direction).

For example, the holder 1110 and the optical member 1120 for changing an optical path may be rotated at a second angle θ2 (Y1 → Y1a) in the Y-axis direction by second electromagnetic forces F2A and F2B between the magnet and the coil described above to implement OIS The second angle θ2 may be in the range of ±1° to 3°. However, the present invention is not limited thereto.

As described above, the first camera actuator according to the embodiment can minimize a decent or shaking phenomenon of an image and provide best optical properties by controlling the electromagnetic forces between the magnet in the holder and the coil disposed on the first actuator housing, that is, by rotating the rotating holder 1110 and the optical member 1120 in the first direction (X-axis direction) or the second direction (Y-axis direction) using the first driving part. In addition, as described above, “Y-axis tilting” corresponds to rotation or tilting in the first direction (X-axis direction), and “X-axis tilting” corresponds to rotation or tilting in the second direction (Y-axis direction).

Referring to FIG. 16, the optical member 1120 for changing an optical path may be disposed on the holder 1110. Accordingly, the optical member 1120 for changing an optical path may change an optical path as described above.

In this case, since the optical member 1120 for changing an optical path may be seated on the holder 1110, the optical member 1120 for changing an optical path may be supported by the holder 1110. In the first camera actuator according to the embodiment, the second driving part M2 may be positioned on an upper surface of the holder 1110.

In other words, the second driving part M2 may be disposed on a surface on which the holder 1110 is in contact with the optical member 1120 for changing an optical path. Alternatively, the second driving part M2 may be disposed between the holder 110 and the optical member 1120 for changing an optical path. In addition, the second driving part M2 may be disposed between the first driving part M1 and the optical member 1120 for changing an optical path.

The second driving part M2 may move the optical member 1120 for changing an optical path, for example, in a piezo manner as described above. To this end, the second driving part M2 may include a first driving sheet M2-1 and a second driving sheet M2-2. The first driving sheet M2-1 and the second driving sheet M2-2 may be stretched or contracted according to an electrical signal. The optical member 1120 on the first driving sheet M2-1 and the second driving sheet M2-2 may also be moved according to the stretching and contraction of the first driving sheet M2-1 and the second driving sheet M2-2. Accordingly, ultimately, X-axis tilting or Y-axis tilting of the optical member 1120 for changing an optical path can be performed.

The first driving sheet M2-1 and the second driving sheet M2-2 may be provided as a plurality of first driving sheets M2-1 and a plurality of second driving sheets M2-2, respectively. In addition, the plurality of first driving sheets M2-1 may be disposed in parallel in one direction (for example, the Y-axis direction) perpendicular to the optical axis.

In addition, the plurality of second driving sheets M2-2 may be disposed in parallel in another direction (Z-axis direction) perpendicular to the optical axis.

In the embodiment, in addition, the first driving sheet M2-1 and the second driving sheet M2-2 may not overlap in the second direction (Y-axis direction) or third direction (Z-axis direction). Accordingly, the X-axis tilting or the Y-axis tilting of the optical member 1120 may be easily performed by the first driving sheet M2-1 and the second driving sheet M2-2.

Referring to FIG. 17, the second camera actuator 1200 according to the embodiment may include the lens part 1210, the second actuator housing HA2, and the first and second driving parts M1 and M2. In addition, the second camera actuator 1200 may further include a second shield can (not shown), an elastic part (not shown), and an adhesive member (not shown).

The second shield can (not shown) may be disposed in one region (for example, at an outermost side) of the second camera actuator 1200 to surround components (the lens part 1210, the second actuator housing HA2, the elastic part (not shown), the first and second driving parts M1 and M2, a base part (not shown), a second substrate part 1270, and the image sensor IS) which will be described below.

The second shield can (not shown) may block or reduce electromagnetic waves generated from the outside. Accordingly, the occurrence of malfunctions in the first and second driving parts M1 and M2 can be reduced.

The lens part 1210 may be positioned in the second shield can (not shown). The lens part 1210 may move in the third direction (Z-axis direction) Accordingly, an AF function or magnification changing function may be performed. In addition, the lens part 1210 may be moved or driven in the first direction or the second direction or tilted by the first and second driving parts M1 and M2 to perform an OIS function.

Specifically, the lens part 1210 may include a lens assembly 1211 and a bobbin 1212.

The lens assembly 1211 may include at least one lens. In addition, the lens assembly 1211 may be provided as a plurality of lens assemblies 1211, but will be described below based on one lens assembly 1211.

The lens assembly 1211 may be coupled to the bobbin 1212 and moved in the third direction (Z-axis direction) or tilted with respect to the first and second directions by an electromagnetic force generated between a magnet coupled to the bobbin 1212 and a coil opposite to the magnet.

The first and second driving parts M1 and M2 may provide a driving force by which the lens part 1210 is moved in the third direction (Z-axis direction). Each of the first and second driving parts M1 and M2 may include a coil and a magnet.

In addition, the lens part 1210 may be moved or driven in the direction perpendicular to the third direction or tilted by the first and second driving parts M1 and M2.

Accordingly, the second camera actuator may be a zoom actuator or an AF or OIS actuator. In addition, the second camera actuator may be a fixed or continuous zoom actuator. For example, the second camera actuator may provide movement of the lens assembly 1211.

The first and second driving parts M1 and M2 may also be installed in the second camera actuator 1200 and may move the lens part 1210 which is the moving part as described above.

Referring to FIG. 18, the image sensor IS may be positioned at the circuit substrate 1300 as described above. In the embodiment, the image sensor IS may be disposed on the circuit substrate 1300.

In addition, the image sensor IS may receive light and convert the received light into an electrical signal. In addition, the image sensor IS may be formed in a form in which a plurality of pixels are arrayed. In addition, the image sensor IS may be positioned on the optical axis.

In this case, the first and second driving parts M1 and M2 may be connected to the image sensor IS and may move the image sensor IS. For example, the first and second driving parts M1 and M2 may horizontally move the image sensor IS in the first direction or the second direction or tilt the image sensor IS.

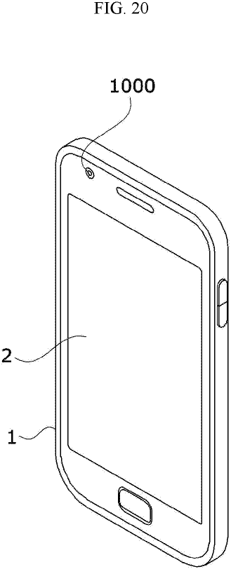

FIG. 19 is a configuration view illustrating a camera module according to another modified embodiment.

Referring to FIG. 19, the camera module according to the modified embodiment may include a housing 100, a lens part including a lens holder 200 and a lens assembly 300, elastic members 400, a base 500, an image sensor 600, a first driving part M1, and a second driving part M2.

Only one of the first driving part M1 and the second driving part M2 may be present, and may be connected to the lens part or the image sensor 600 which is a moving part to move at least one of the lens part and the image sensor 600.

The first driving part M1 and the second driving part M2 may move the moving part according to various embodiments described above, and the above-described content may be equally applied to the modified embodiment aside from the following content.

In addition, in the present embodiment, the lens part may include a liquid lens part LL. The liquid lens part may include a first liquid which is conductive and a second liquid which is not conductive, and an interface at which the first liquid and the second liquid are in contact with each other may be deformed by an applied voltage. That is, the interface may have different curvatures according to the voltage. Accordingly, an optical path may be changed, and a focal point may also be changed. In other words, OIS function may also be performed by controlling the liquid lens part LL.

In addition, the first driving part M1 or the second driving part M2 may be disposed above the base 500 or in the housing 100 In addition, the first driving part M1 or the second driving part M2 may move the lens part or the image sensor 600. For example, the second driving part M2 may move the lens part or the image sensor 600.

In addition, in the camera module according the modified embodiment, since the moving part is moved by the first driving part M1 or the second driving part M2, the number of moving parts is minimized, and thus vibration due to the movement of the moving parts can be minimized. Accordingly, the reliability of the camera module can be improved.

Hereinafter, a structure of an electronic device according to the present embodiment will be described.

FIG. 20 is a view illustrating an electronic device including a camera module according to an embodiment.

Referring to FIG. 20, the electronic device may be any one among a handphone, a portable phone, a smart phone, a portable communication device, a portable smart device, a digital camera, a laptop computer, a digital broadcasting terminal, a personal digital assistant (PDA), a portable multimedia player (PMP), and a navigation device. However, the types of the electronic device are not limited thereto, and any device for capturing an image may be included in the electronic device.

The electronic device may include a main body 1. The main body 1 may form an exterior of the electronic device. The main body 1 may accommodate a camera module 1000. A display 2 may be disposed on one surface of the main body 1. As an example, the display 2 and the camera module 1000 may be disposed on one surface of the main body 1, and a camera module 1000 may be additionally disposed on the other surface (positioned at a side opposite to one surface) of the main body 1.

The electronic device may include the display 2. The display 2 may be disposed on one surface of the main body 1. The display 2 may output an image captured by the camera module 1000.

The electronic device may include the camera module 1000. The camera module 1000 may be disposed in the main body 1. At least a part of the camera module 1000 may be accommodated in the main body 1. The camera module 1000 may be provided as a plurality of camera modules 1000. The camera modules 1000 may include a dual camera device. The camera module 1000 may be disposed on each of one surface of the main body 1 and the other surface of the main body 1. The camera module 1000 may capture an image of a subject.

While the present invention has been mainly described above with reference to embodiments, it will be understood by those skilled in the art that the present invention is not limited to the embodiments, but the embodiments are only exemplary, and various modifications and applications which are not illustrated above may fall within the range of the present invention without departing from the essential features of the present embodiments. For example, components specifically described in the embodiments may be modified and implemented, and the driving parts described in the present specification may include components which generate forces in order to move the moving part in addition to the components described in the embodiments. In addition, it should be understood that differences related to modifications and applications fall within the scope of the present invention defined by the appended claims.

1. A camera module comprising:
a fixed part;
a moving part which moves relative to the fixed part in an optical axis direction;
a first driving part which moves the moving part at a first maximum speed; and
a second driving part which moves the moving part at a second maximum speed,
wherein the first driving part and the second driving part move the moving part in a direction perpendicular to the optical axis direction, and
the second maximum speed is higher than the first maximum speed.

2. The camera module of claim 1, wherein:
the fixed part includes at least one of a housing and a base; and
the moving part includes at least one of a lens part and an image sensor.

3. The camera module of claim 2, wherein:
the lens part is disposed in the housing;
the lens part includes a lens holder and a lens assembly disposed in the lens holder; and
the image sensor is disposed in the base.

4. The camera module of claim 1, wherein the first driving part moves the moving part to correspond to a shaking angle.

5. The camera module of claim 4, wherein the second driving part moves the moving part to compensate for a difference between the shaking angle and a moving angle caused by the first driving part.

6. The camera module of claim 5, wherein the second driving part moves the moving part to correspond to an error between the first driving part and the shaking angle at a different time after the first driving part moves the moving part at the moving angle.

7. The camera module of claim 3, wherein the first driving part and the second driving part are selectively controlled according to a focal length between the lens assembly and the image sensor.

8. The camera module of claim 7, wherein, when the focal length is greater than a first threshold, the moving part is moved by the first driving part and the second driving part.

9. The camera module of claim 8, wherein:
when the focal length is smaller than the first threshold and greater than a second threshold, the moving part is moved by the first driving part; and
the first threshold is greater than the second threshold.

10. The camera module of claim 9, wherein, when the focal length is smaller than the second threshold, the moving part is moved by the second driving part.
